(19) United States
(12) Patent Application Publication
(10) Pub. No.: US 2026/0342175 A1
(43) Pub. Date: Oct. 29, 2026

(54) POWER TOOL

(71) Applicant: MAKITA CORPORATION, Anjo-shi, Aichi (JP)

(72) Inventors: Yoshihiro ITO, Anjo-shi (JP); Hidenori NAGASAKA, Anjo-shi (JP); Koji TAKAHAGI, Anjo-shi (JP); Jun UEDA, Anjo-shi (JP)

(73) Assignee: MAKITA CORPORATION, Anjo-shi, Aichi (JP)

(21) Appl. No.: 19/648,741

(22) Filed: Apr. 15, 2026

(30) Foreign Application Priority Data
Apr. 28, 2025 (JP) 2025-074019

(51) Int. Cl. H02K 9/14; H02K 5/20; H02K 7/00; H02K 7/08; B25F 5/00

(52) U.S. Cl. CPC H02K 9/14; H02K 5/20; H02K 7/003; H02K 7/08; B25F 5/008

(57) ABSTRACT

A power tool includes: a brushless electric motor including a rotor, a stator, and a motor shaft; a first bearing that is arranged on a first side relative to the rotor and the stator in an axial direction in which the motor shaft extends, and rotatably supports the motor shaft; a second bearing that is arranged on a second side opposite to the first side in the axial direction, and rotatably supports the motor shaft; a housing including at least one inlet on the first side and at least one outlet on the second side, and housing the brushless electric motor therein; and a bracket supporting the first bearing. The bracket includes at least one flow passage groove configured to direct motor cooling air flowing into the housing from the at least one inlet, toward the brushless electric motor.

### TECHNICAL FIELD

The present disclosure relates to a power tool.

### BACKGROUND

A driver drill having a brushless electric motor is conventionally known as a kind of power tool (for example, Japanese non-examined laid-open patent publication No. 2024-175645). In such a driver drill, torque is large, so that the amount of heat generation of the brushless electric motor is increased. Therefore, the driver drill is provided with a structure for cooling the brushless electric motor. Specifically, the driver drill includes a housing having an inlet on one side of the brushless electric motor and an outlet on the other side. Air flows into the housing from the inlet by rotation of a fan fixed to a motor shaft, and is led through the brushless electric motor and then discharged from the outlet. The brushless electric motor is cooled by this air flow.

### SUMMARY

A power tool is disclosed in this specification. The power tool may include: a brushless electric motor including a rotor, a stator, and a motor shaft; a first bearing that is arranged on a first side relative to the rotor and the stator in an axial direction in which the motor shaft extends, and rotatably supports the motor shaft; a second bearing that is arranged on a second side opposite to the first side in the axial direction, and rotatably supports the motor shaft; a housing that houses the brushless electric motor therein; and a bracket supporting the first bearing. The housing may include at least one inlet on the first side and at least one outlet on the second side. The bracket may include at least one flow passage groove configured to direct motor cooling air flowing into the housing from the at least one inlet, toward the brushless electric motor.

According to this power tool, the bracket that is provided to support the first bearing has the at least one flow passage groove that directs the motor cooling air toward the brushless electric motor. Thus, the flow passage of the motor cooling air is provided with an efficient flow path of the motor cooling air from the at least one inlet to the brushless electric motor without the need to provide an additional part. Therefore, the pressure loss of the flow passage is reduced, and the brushless electric motor is efficiently cooled.

Another power tool is disclosed in this specification. The power tool may include a brushless electric motor. The brushless electric motor may include a rotor, a stator including a plurality of teeth around which coils are wound, and a motor shaft having a rotational axis. The power tool may further include a first bearing that is arranged on a first side relative to the rotor and the stator in an axial direction in which the rotational axis extends, and rotatably supports the motor shaft; a second bearing that is arranged on a second side opposite to the first side in the axial direction, and rotatably supports the motor shaft; a housing that houses the brushless electric motor therein; and a heat sink. The housing may include at least one inlet on the first side and at least one outlet on the second side. The heat sink may be arranged in contact with the coils wound around the plurality of teeth, in a flow passage of motor cooling air that flows into the housing from the at least one inlet and is discharged from the at least one outlet.

According to this power tool, the brushless electric motor is efficiently cooled by the heat sink that is arranged in the flow passage of the motor cooling air. Further, the brushless electric motor generates heat mainly at the coils wound around the teeth, so that the cooling efficiency is further improved by provision of the heat sink arranged in contact with the coils.

Another power tool is disclosed in this specification. The power tool may include a brushless electric motor. The brushless electric motor may include a rotor, a stator including a plurality of teeth around which coils are wound, and a motor shaft having a rotational axis. The power tool may further include a first bearing that is arranged on a first side relative to the rotor and the stator in an axial direction in which the rotational axis extends, and rotatably supports the motor shaft; a second bearing that is arranged on a second side opposite to the first side in the axial direction, and rotatably supports the motor shaft; a housing that houses the brushless electric motor therein; and a heat sink. The housing may include at least one inlet on the first side and at least one outlet on the second side. The heat sink may be arranged in contact with the brushless electric motor, in a flow passage of motor cooling air that flows into the housing from the at least one inlet and is discharged from the at least one outlet. The heat sink may include a plurality of fins. A plurality of spaces between the plurality of fins may function as flow passages that lead the motor cooling air from the at least one inlet to the brushless electric motor, or flow passages that lead the motor cooling air from the brushless electric motor to the at least one outlet.

According to this power tool, the brushless electric motor is efficiently cooled by the heat sink that is arranged in the flow passage of the motor cooling air. Further, the spaces between the plurality of fins of the heat sink function as flow passages that lead the motor cooling air from the inlet to the brushless electric motor, or flow passages that lead the motor cooling air from the brushless electric motor to the outlet, so that the motor cooling air is efficiently led in a desired direction. Therefore, the pressure loss of the flow passage is reduced, and the brushless electric motor is efficiently cooled.

### BRIEF DESCRIPTION OF THE DRAWINGS

FIG. 1 is a perspective view of a driver drill according to a first embodiment.

FIG. 2 is a right side view of the driver drill.

FIG. 3 is a left side view of the driver drill.

FIG. 4 is a vertical sectional view of the driver drill.

FIG. 5 is a partial enlarged view of FIG. 4.

FIG. 6 is a partial sectional view taken along line A-A in FIG. 3.

FIG. 7 is a front view of a motor, with an insulator removed therefrom.

FIG. 8 is a perspective view of a bracket.

FIG. 9 is a partial enlarged left side view of a driver drill according to a second embodiment, with part of a housing removed therefrom.

FIG. 10 is a perspective view for showing the mounted state of a heat sink according to a second embodiment.

FIG. 11 is a partial sectional view of a driver drill according to the second embodiment.

FIG. 12 is a partial sectional view taken along line B-B in FIG. 9.

FIG. 13 is a perspective view of the heat sink.

FIG. 14 is a left side view of the heat sink.

FIG. 15 is a perspective view of a stator of a motor.

### DETAILED DESCRIPTION OF THE EMBODIMENTS

In the following description, representative and non-limiting specific examples of the present invention will be described in detail with reference to the drawings. This detailed description is merely intended to teach a person of skill in the art details for practicing preferred examples of the present invention and is not intended to limit the scope of the present invention. Furthermore, each of additional features and inventions disclosed below can be utilized separately from or together with other features and inventions to provide further improved apparatuses and methods for manufacturing and using the same.

Moreover, combinations of features and steps disclosed in the following detailed description are not necessary to practice the present invention in the broadest sense, and are instead taught merely to particularly describe a representative specific example of the present invention. Furthermore, various features of the above-described and the following representative examples, as well as various features recited in the independent and dependent claims below, do not necessarily have to be combined in herein specifically exemplified manners or enumerated orders to provide additional and useful embodiments of the present invention.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges and indications of groups or aggregations are intended to disclose every possible intermediate individual forming them for the purpose of original written disclosure, as well as for the purpose of restricting the claimed subject matter.

In one or more embodiments, the at least one flow passage groove may be located at a position corresponding to the at least one inlet in the axial direction. With this structure, the at least one inlet and the at least one flow passage groove are in communication with each other via the shortest flow path in the axial direction, so that the flow path of the motor cooling air from the at least one inlet to the brushless electric motor is further improved in efficiency in the axial direction, and the brushless electric motor is more efficiently cooled.

In one or more embodiments, the at least one flow passage groove may be located at a position corresponding to the at least one inlet in a circumferential direction relative to the motor shaft. With this structure, the at least one inlet and the at least one flow passage groove are in communication with each other via the shortest flow path in the circumferential direction, so that the flow path of the motor cooling air from the at least one inlet to the brushless electric motor is further improved in efficiency in the circumferential direction, and the brushless electric motor is more efficiently cooled.

In one or more embodiments, the at least one inlet may include a plurality of inlets. The at least one flow passage groove may include a plurality of flow passage grooves that are respectively located at a plurality of positions corresponding to the plurality of inlets. With this structure, the motor cooling air is efficiently led from all of the inlets to the brushless electric motor through the plurality of flow passage grooves.

In one or more embodiments, the stator may include a plurality of teeth around which coils are wound. The at least one flow passage groove may be configured to direct the motor cooling air to flow through a clearance between the plurality of teeth around which the coils are wound. With this structure, the brushless electric motor is efficiently cooled by contact of the motor cooling air with the coils that generate heat.

In one or more embodiments, the at least one flow passage groove may have a passage width that decreases from an upstream side toward a downstream side of the motor cooling air. With this structure, the motor cooling air is efficiently led into a clearance between the plurality of teeth, when the clearance between the plurality of teeth is smaller than the inlet.

In one or more embodiments, the power tool may include a heat sink that is arranged in contact with the coils wound around the plurality of teeth, in a flow passage of the motor cooling air. With this structure, the brushless electric motor is efficiently cooled by the heat sink. Further, the brushless electric motor generates heat mainly in the coils wound around the plurality of teeth, so that the cooling efficiency is further improved by provision of the heat sink arranged in contact with the coils.

In one or more embodiments, the heat sink may include a plurality of fins that are arranged in contact with the coils wound around the plurality of teeth. With this structure, the cooling efficiency is further improved by provision of the plurality of fins.

In one or more embodiments, the plurality of fins may be arranged to extend radially relative to the rotational axis. A plurality of spaces between the plurality of fins may function as flow passages that lead the motor cooling air in a radial direction relative to the rotational axis. With this structure, the motor cooling air is led in the radial direction through an efficient flow path by the plurality of fins, while the cooling efficiency is improved by provision of the plurality of fins.

In one or more embodiments, the plurality of spaces may include a first space in which a distance in a circumferential direction relative to the rotational axis between two fins adjacent in the circumferential direction is a first distance, and a second space in which a distance in the circumferential direction between the two fins adjacent in the circumferential direction is a second distance larger than the first distance. The second space may be located at least at a position corresponding to a clearance between the plurality of teeth around which the coils are wound. With this structure, the second space through which the motor cooling air passes most easily is located at a position corresponding to a clearance between the plurality of teeth, so that the brushless electric motor is further efficiently cooled by contact of a larger amount of the motor cooling air with the coils (heat generating parts) that generate heat.

In one or more embodiments, each of the plurality of fins may include a tip that has a shape conforming to the coil wound around the teeth. With this structure, the area of contact between the plurality of fins and the coil is increased, so that the brushless electric motor is more efficiently cooled by the plurality of fins.

In one or more embodiments, the heat sink may be located at a position corresponding to the at least one inlet in the axial direction. With this structure, the motor cooling air of a relatively low temperature before passing through the brushless electric motor comes into contact with the heat sink. Therefore, the cooling efficiency by the heat sink is improved.

In one or more embodiments, the power tool may have an insulator that surrounds the coils wound around the plurality of teeth, along a circumferential direction on an outer side of the coils in a radial direction. The heat sink may be screwed to the insulator. With this structure, the heat sink is mounted by a simple structure.

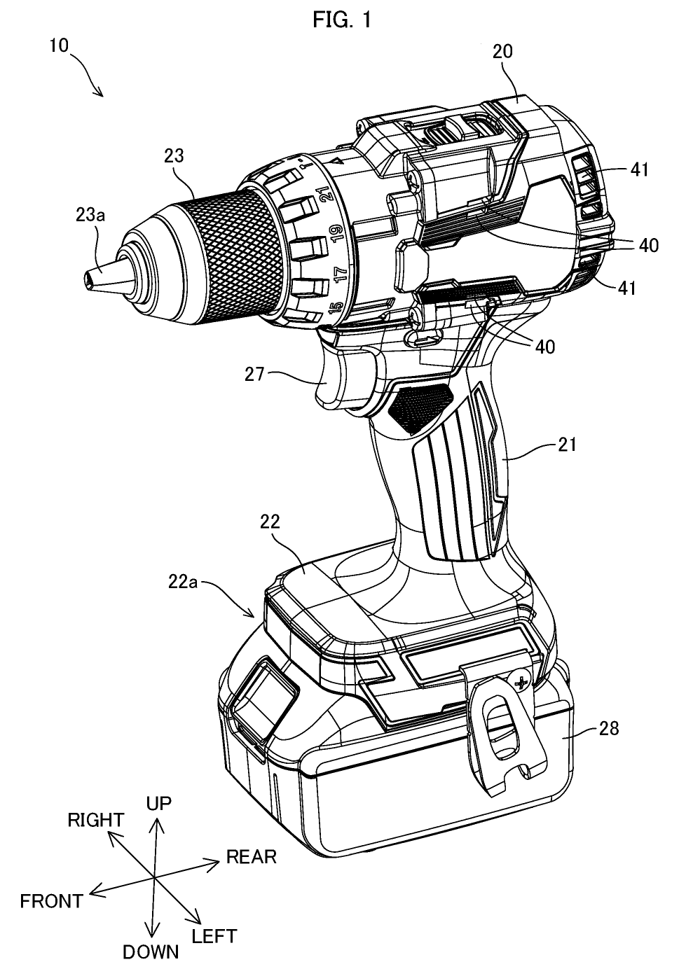

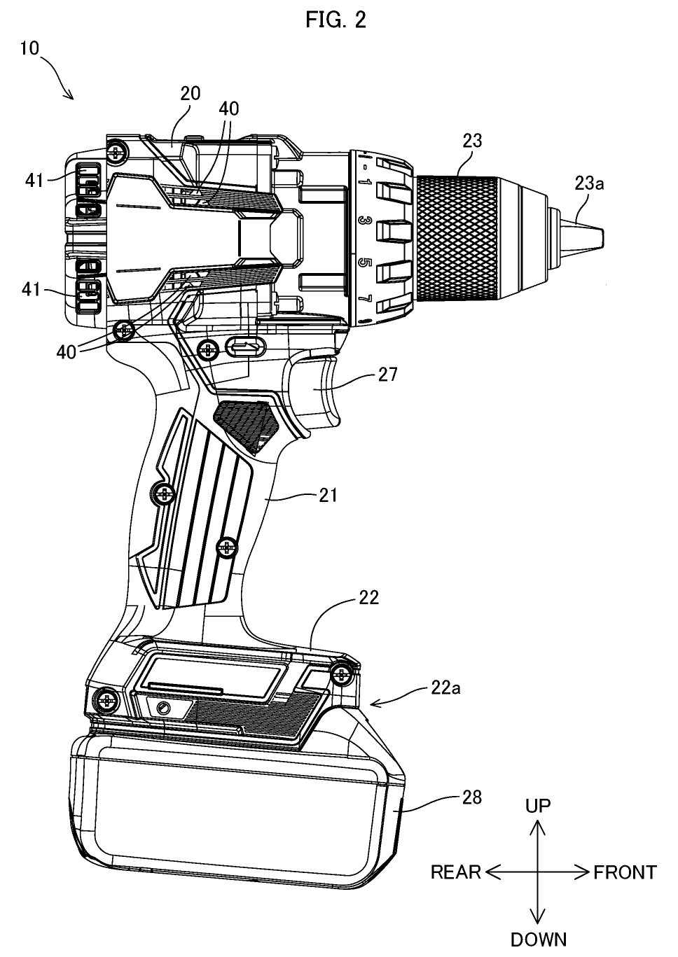

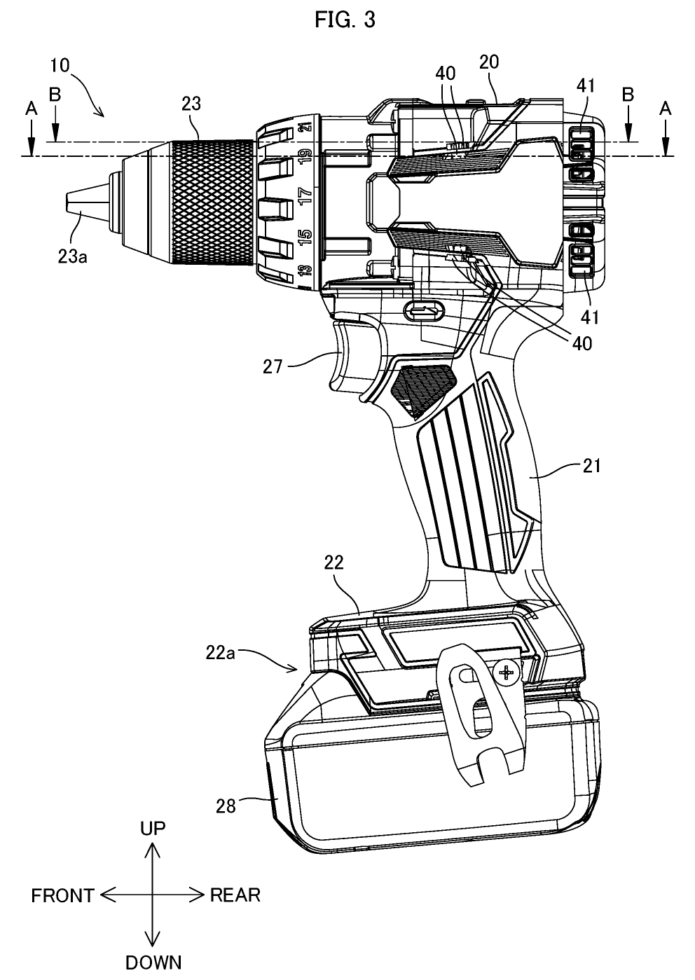

A driver drill 10 according to a first embodiment is now specifically described as a representative and non-limiting example of a power tool of the present disclosure with reference to the drawings. As shown in FIGS. 1-4, the driver drill 10 includes a main housing 20, a handle housing 21, a battery holding part 22 and a chuck 23.

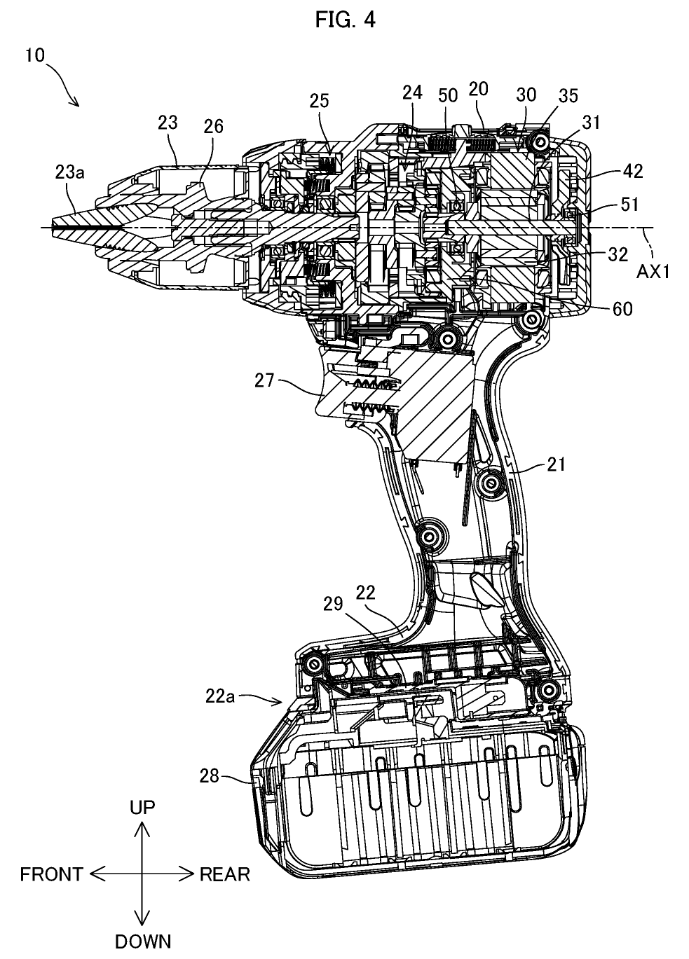

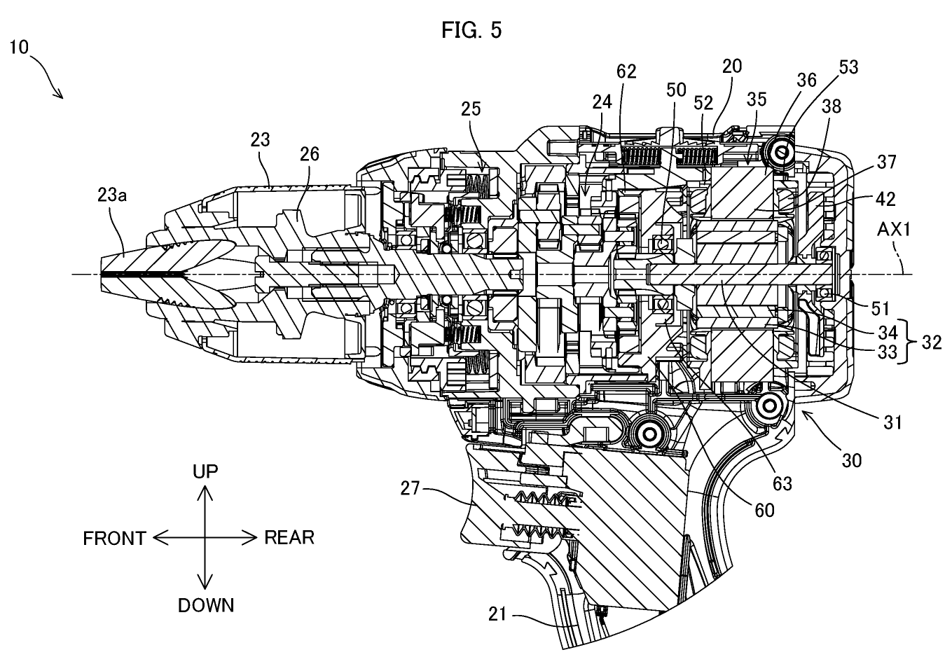

As shown in FIGS. 4-5, the main housing 20 has a cylindrical shape and houses a brushless electric motor (hereinafter simply referred to as a motor) 30, a speed reducing mechanism 24, a vibration mechanism 25 and a spindle 26. The motor 30 includes a motor shaft 31 having a rotational axis AX1. A direction in which the rotational axis AX1 extends coincides with a longitudinal direction of the main housing 20. In the following description, the direction in which the rotational axis AX1 extends (a direction in which the motor shaft 31 extends) is also referred to as an axial direction, and a direction orthogonal to the axial direction is also referred to as a radial direction. A direction around the rotational axis AX1 is also referred to as a circumferential direction.

The spindle 26 is coaxial with the motor shaft 31. The spindle 26 is operably connected to the motor shaft 31 via the speed reducing mechanism 24 and the vibration mechanism 25. The chuck 23 has a cylindrical shape and includes a claw part 23a that is formed on its front end for holding a tool accessory. The chuck 23 is operably coupled to a front end (an end on the opposite side from the motor 30) of the spindle 26 on the opposite side from the claw part 23a. When the motor 30 is driven, rotational driving force is transmitted to the chuck 23 via the speed reducing mechanism 24 and the spindle 26, and then provided to the tool accessory held by the chuck 23. The driver drill 10 can switch between vibration mode and non-vibration mode. In vibration mode, the vibration mechanism 25 oscillates the claw part 23a in the axial direction. Such a mechanical structure of the driver drill 10 is well known and therefore its detailed description is omitted herein.

As shown in FIGS. 1-4, the handle housing 21 extends elongatedly in a direction crossing (more specifically, a direction generally orthogonal to) the rotational axis AX1. The handle housing 21 is a part to be held by a user in use of the driver drill 10. One end of the handle housing 21 is connected to the main housing 20, and the other end is connected to the battery holding part 22. A trigger 27 is provided on the one end of the handle housing 21 and operated to start and stop the motor 30.

In the following description, for convenience of description, the extending direction of the rotational axis AX1 is defined as a front-rear direction of the driver drill 10. In the front-rear direction, the side on which the chuck 23 is arranged is defined as the front side of the driver drill 10, and the opposite side is defined as the rear side of the driver drill 10. A direction orthogonal to the rotational axis AX1 and generally parallel to the extending direction of the handle housing 21 is defined as an up-down direction of the driver drill 10. In the up-down direction, the side on which the main housing 20 is arranged is defined as an upper side of the driver drill 10, and the side on which the battery holding part 22 is arranged is defined as a lower side of the driver drill 10. A direction orthogonal to the front-rear direction and the up-down direction is defined as a left-right direction of the driver drill 10. In the left-right direction, the right side as viewed from the rear is defined as the right side of the driver drill 10, and its opposite side is defined as the left side of the driver drill 10.

As shown in FIGS. 1-4, the battery holding part 22 includes a battery mounting part 22a that is configured such that a battery 28 as a power source of the driver drill 10 is removably mounted thereto. The battery mounting part 22a includes an electrical terminal that is an interface for electrical connection with the battery 28, and a guide that is an interface for mechanical connection with the battery 28.

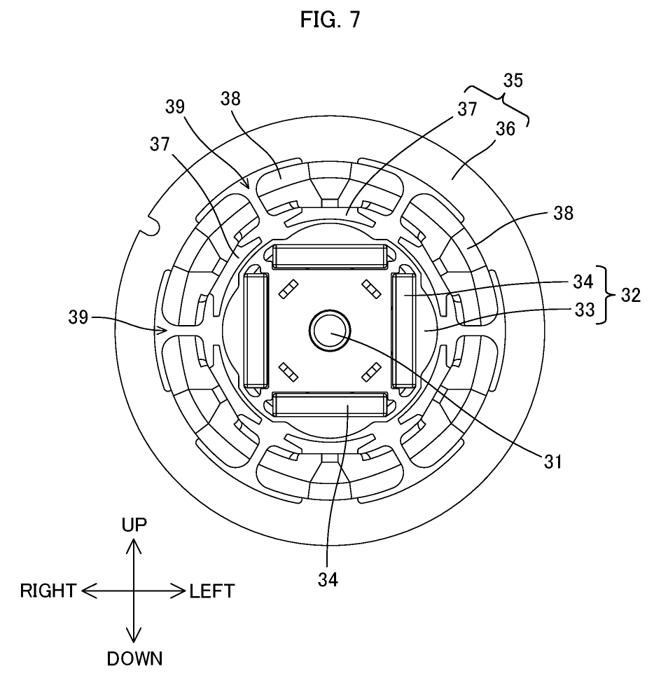

As shown in FIGS. 5 and 7, the motor 30 is an inner rotor type brushless motor, and includes a rotor 32 and a stator 35 as well as the motor shaft 31. The rotor 32 includes a rotor core 33 and four magnets 34. In this embodiment, the rotor 32 has four poles, but the number of poles may be freely set. As shown in FIG. 7, the stator 35 includes an annular yolk 36 and six teeth 37 extending radially inward from the yolk 36. A slot 39 is defined between two teeth 37 adjacent to each other. In this embodiment, six slots 39 are provided, but the number of the slots 39 can be arbitrarily set. Coils 38 are wound around the teeth 37 through the slots 39.

As shown in FIG. 5, a front insulator 52 surrounds part of the coils 38, which are wound around the teeth 37 and located in front of the teeth 37, along the circumferential direction on the outer side of the coils 38 in the radial direction. A rear insulator 53 surrounds part of the coils 38, which are wound around the teeth 37 and located behind the teeth 37, along the circumferential direction on the outer side of the coils 38 in the radial direction.

As shown in FIG. 4, a controller 29 is housed in the battery holding part 22. The controller 29 includes a processor and a memory and controls the whole operation of the driver drill 10. The controller 29 includes a switching circuit (inverter circuit) having switching elements such as a transistor and an FET, and controls operation of the motor 30 by PWM control. In this embodiment, the motor 30 is a so-called sensorless brushless motor. Thus, the motor 30 does not include a sensor substrate with a sensor (such as a Hall IC) for detecting the rotational angular position of the rotor 32. Therefore, the controller 29 obtains a voltage value of a wiring of each phase for supplying three-phase power to the motor 30 and performs prescribed signal processing based on the obtained voltage value for each phase, and outputs a position detection signal. The controller 29 then detects the rotational angular position of the motor 30 based on the position detection signal for each phase.

As shown in FIG. 5, the motor shaft 31 is rotatably supported by a first bearing 50 and a second bearing 51 that are arranged apart from each other in the front-rear direction. The first bearing 50 is arranged in front of the rotor 32 and the stator 35, and the second bearing 51 is arranged behind the rotor 32 and the stator 35.

As shown in FIG. 5, a motor cooling fan 42 is fitted onto the motor shaft 31. The motor cooling fan 42 is arranged between the rotor 32 and the second bearing 51 in the front-rear direction. The motor cooling fan 42 generates motor cooling air for cooling the motor 30. In this embodiment, the motor cooling fan 42 is a so-called radial fan, and leads the motor cooling air sucked from the front of the motor 30, outward in the radial direction.

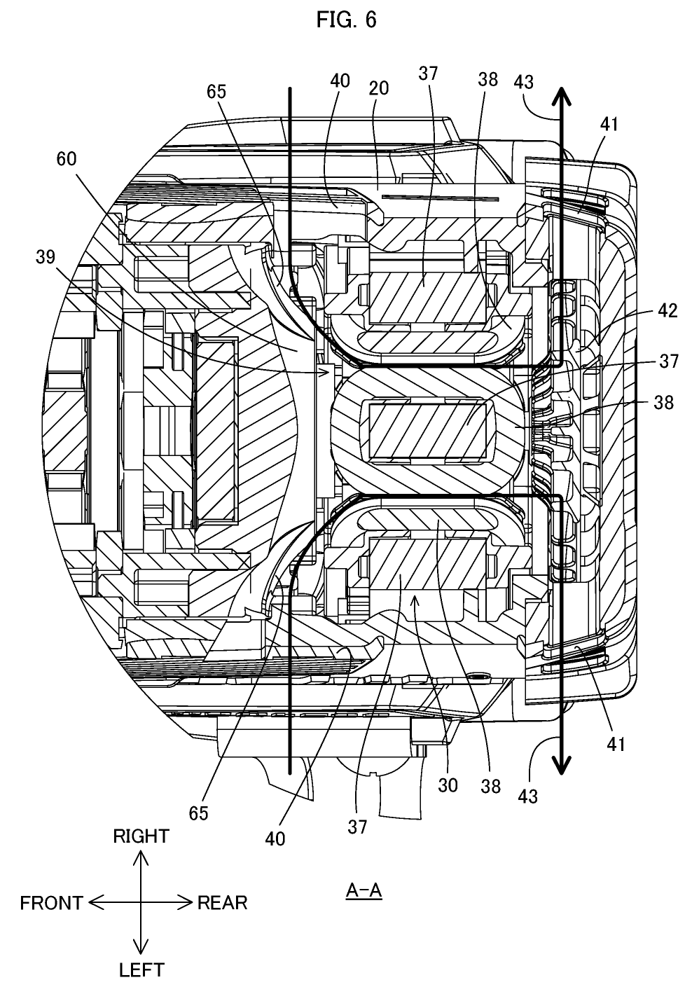

As shown in FIGS. 1-3, the main housing 20 includes inlets 40 and outlets 41 for the motor cooling air. In this embodiment, four inlets 40 and eight outlets 41 are defined on each of left and right surfaces of the main housing 20. The numbers of the inlets 40 and the outlets 41 are not particularly limited, and may be one or more any arbitrary number. As shown in FIG. 6, in this embodiment, the eight inlets 40 are arranged generally at the same position in the front-rear direction and in front of the rotor 32 and the stator 35. The sixteen outlets 41 are arranged generally at the same position in the front-rear direction and behind the rotor 32 and the stator 35.

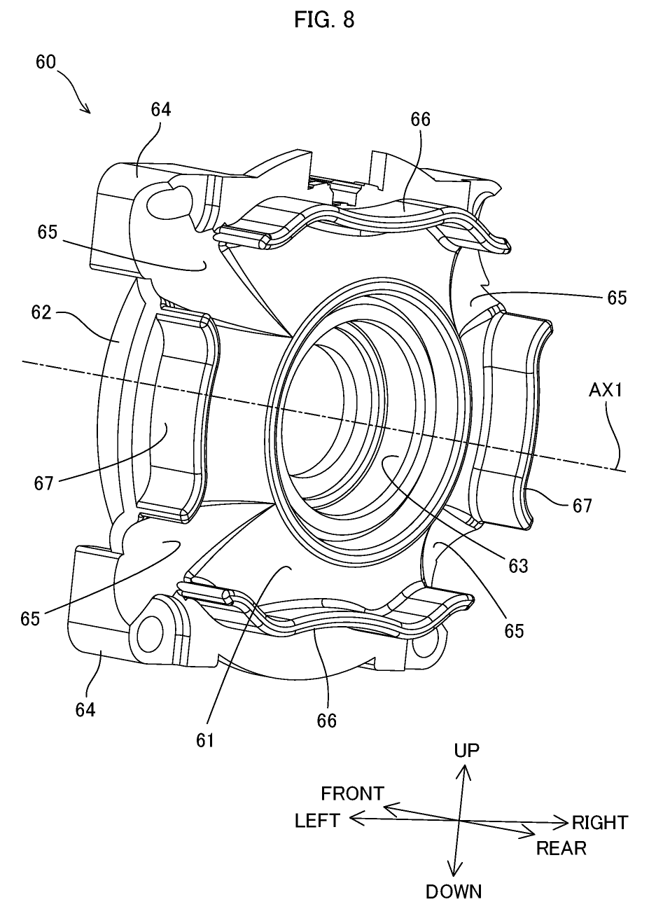

As shown in FIG. 5, part of the speed reducing mechanism 24 and the first bearing 50 are supported by a bracket 60. As shown in FIG. 8, the bracket 60 is a cylindrical member and arranged coaxially with the rotational axis AX1. The bracket 60 includes a conical cylinder part 61 and a gear holding part 62. The conical cylinder part 61 is defined in a rear part of the bracket 60, and has a generally conical external shape having an outside diameter that decreases toward the rear. A bearing support part 63 is defined on the inside of the conical cylinder part 61 and supports the first bearing 50. The gear holding part 62 is defined on the front side of the bracket 60 and cylindrically extends forward. The gear holding part 62 supports part of the speed reducing mechanism 24 in its inside.

As shown in FIG. 8, the bracket 60 further includes four screw bosses 64. The screw bosses 64 are defined at four corners of the bracket 60 in the up-down direction and the left-right direction. The screw bosses 64 are used to mount the bracket 60 to a gear case for housing the speed reducing mechanism 24. The bracket 60 further includes four flow passage grooves 65 respectively adjacent to the four screw bosses 64. Each of the flow passage grooves 65 is defined on the conical cylinder part 61 in such a shape that an outer surface of the conical cylinder part 61 is notched. The flow passage groove 65 extends from a radially outer edge to a radially inner edge of the conical cylinder part 61. As shown in FIGS. 6 and 8, the flow passage groove 65 includes a curved surface, and smoothly directs the motor cooling air flowing into the main housing 20 from the inlets 40, to the motor 30 along the curved surface of the flow passage groove 65.

FIG. 6 shows a flow passage 43 of the motor cooling air directed by the flow passage grooves 65. The motor cooling air flowing into the main housing 20 from the inlets 40 passes through the motor 30 rearward from the front, while gradually changing the flow direction toward the rear along the curved surfaces of the flow passage grooves 65. The air flow is then changed in the flow direction to a radially outward direction by the motor cooling fan 42, and discharged from the outlets 41. With this structure, the bracket 60 that is an existing component of the driver drill 10 includes the flow passage grooves 65, so that the flow path of the flow passage 43 is improved in efficiency without need for providing an additional part. In other words, the flow passage 43 is provided as a smooth passage that does not obstruct the flow of the motor cooling air, and is shortened. Therefore, the pressure loss of the flow passage 43 is reduced, and the motor 30 is efficiently cooled.

As shown in FIG. 6, in this embodiment, the flow passage groove 65 directs the motor cooling air to pass through a clearance between the adjacent teeth 37 around which the coils 38 are wound (that is, a clearance between the adjacent coils 38 of different phases in the slot 39). With this structure, the motor cooling air comes into contact with the coils 38 that are heat generating parts, so that the motor 30 is efficiently cooled. Further, as shown in FIG. 8, the flow passage groove 65 has a passage width that decreases from the upstream side to the downstream side of the motor cooling air. In this embodiment, the clearance between the two coils 38 through which the motor cooling air passes is smaller than the inlet 40. By provision of the flow passage groove 65 having such a width between the inlet 40 and this clearance, the width of the flow passage from the inlet 40 to this clearance is smoothly changed. Thus, generation of a turbulent flow is reduced or eliminated, and the motor cooling air is efficiently led into the clearance between the two coils.

As shown in FIG. 6, in this embodiment, the flow passage grooves 65 are arranged at a position corresponding to the inlets 40 in the front-rear direction. The expression "arranged at a position corresponding to the inlets 40 in the front-rear direction" means that the flow passage grooves 65 and the inlets 40 at least partially overlap each other when viewed in a direction orthogonal to the front-rear direction, or that the flow passage grooves 65 and the inlets 40 are adjacent to each other in the front-rear direction. With this structure, the flow passage grooves 65 and the inlets 40 are in communication with each other via the shortest flow path in the axial direction, so that the flow path of the motor cooling air from the inlets 40 to the motor 30 is further improved in efficiency in the axial direction, and the motor 30 is more efficiently cooled.

Similarly, as shown in FIG. 6, in this embodiment, the flow passage grooves 65 are arranged at positions corresponding to the inlets 40 in the circumferential direction. Although not shown, the flow passage groove 65 is also arranged at a position corresponding to the two adjacent inlets 40 in the circumferential direction. With this structure, the flow passage grooves 65 and the inlets 40 are in communication with each other via the shortest flow path in the circumferential direction, so that the flow path of the motor cooling air from the inlets 40 to the motor 30 is further improved in efficiency in the circumferential direction, and the motor 30 is more efficiently cooled.

As shown in FIG. 8, the bracket 60 further includes a pair of side walls 66 facing each other in the up-down direction and a pair of side walls 67 facing each other in the left-right direction. The side walls 66, 67 extend rearward from the conical cylinder part 61. The side walls 66 are located near upper and lower edge parts of the conical cylinder part 61, and the side walls 67 are located near right and left edge parts of the conical cylinder part 61.

Each of the side walls 66 extends between an upstream-side inner edge of the right flow passage groove 65 and an upstream-side inner edge of the left flow passage groove 65 in the left-right direction. Each of the side walls 67 extends between an upstream-side lower edge of the upper flow passage groove 65 and an upstream-side upper edge of the lower flow passage groove 65 in the up-down direction. In other words, the side walls 66, 67 surround regions of the conical cylinder part 61 in the circumferential direction except for the regions in which the flow passage grooves 65 are formed in the circumferential direction. Thus, the side walls 66, 67 guide the motor cooling air from the inlets 40 to the motor 30 through the flow passage grooves 65. Therefore, generation of a turbulent flow is further reduced or eliminated, and the motor 30 is more efficiently cooled.

As described above, the driver drill 10 uses a sensorless brushless motor as the motor 30, so that an installation space for a sensor substrate is not needed. Therefore, the flow path of the motor cooling air is improved in efficiency by the flow passage grooves 65 without increasing the tool size in the front-rear direction, compared with a driver drill including a sensor substrate. Thus, the cooling efficiency for the motor 30 is improved.

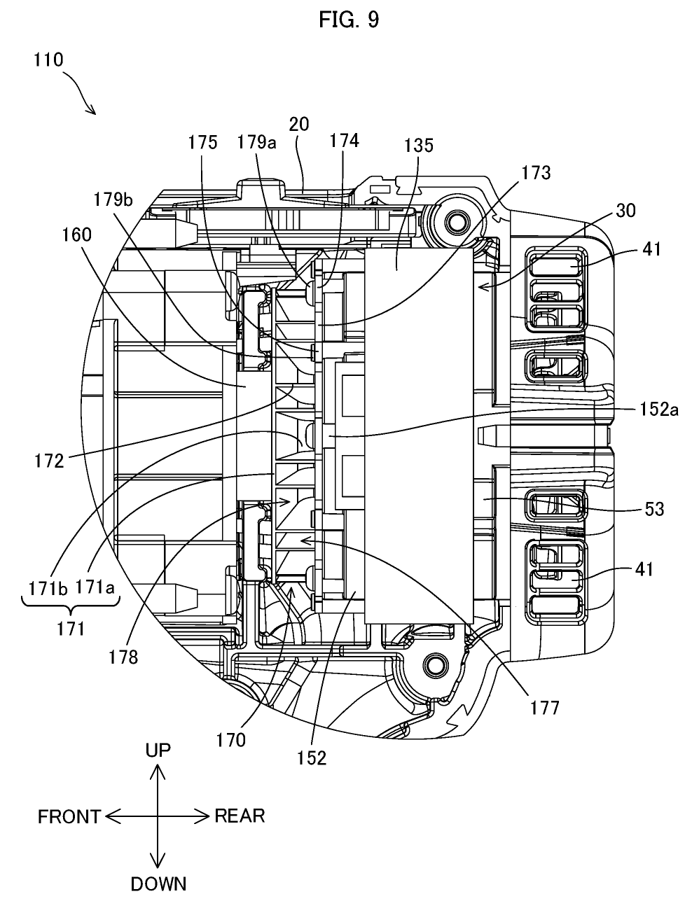

Next, a driver drill 110 according to a second embodiment is described. The driver drill 110 is different from that of the first embodiment in part of the structure for cooling the motor 30. Only the points different from the first embodiment are now described with reference to FIGS. 9 - 15. In the drawings of the second embodiment, components that are identical to those of the first embodiment are given the same numerals as in the first embodiment. As shown in FIG. 9, the driver drill 110 includes a heat sink 170. Further, the driver drill 110 includes a bracket 160, a stator 135 and a front insulator 152 in place of the bracket 60, the stator 35 and the front insulator 52 of the first embodiment. Like in the first embodiment, the bracket 160 supports part of the speed reducing mechanism 24 and the first bearing 50. The bracket 160 has the same shape as that of a conventional driver drill that does not include the flow passage grooves 65, and is therefore not described in detail below.

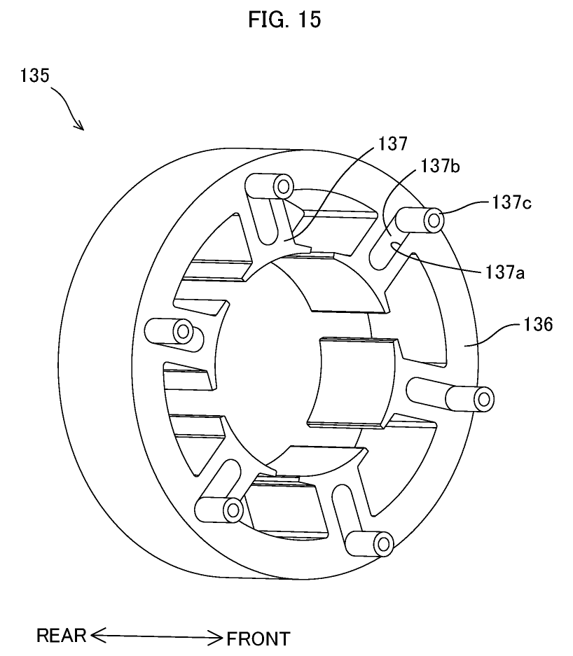

As shown in FIG. 15, the stator 135 includes an annular yolk 136 and six teeth 137. Each of the teeth 137 has a through hole 137aextending therethrough in the front-rear direction. The through hole 137a is an elongate hole that is long in the radial direction. A positioning member 137bhaving such a size and a shape that conform to the through hole 137a is fitted into each of the through holes 137a. Each of the positioning member 137b includes a screw boss 137c extending in the front-rear direction. The screw boss 137c protrudes forward from a front edge part of the yolk 136. The positioning member 137b is used to position the relative position of the motor 30 and the heat sink 170, which is described in detail below.

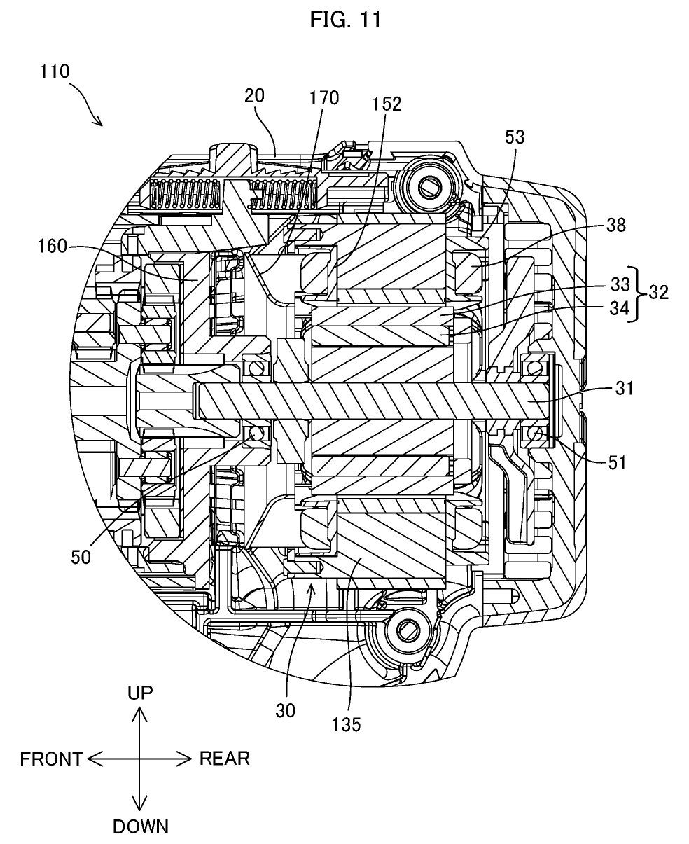

As shown in FIGS. 9 and 11, the heat sink 170 is arranged between the bracket 160 and the stator 135 in the front-rear direction. This installation space for the heat sink 170 corresponds to a space for a sensor substrate, provided that the driver drill 10 includes a sensor substrate.

As shown in FIGS. 9, 10, 13 and 14, the heat sink 170 includes a base 171, fins 172, and a mounting ring 173. The base 171 is a cylindrical part defined on the front side of the heat sink 170, and includes a tapered cylindrical part 171a and a cylindrical part 171b. The tapered cylindrical part 171a has a shape in which an outer diameter and an inner diameter thereof gradually decrease rearward from the front. The cylindrical part 171b cylindrically extends rearward from a rear edge of the tapered cylindrical part 171a. The fins 172 are arranged to extend radially relative to the rotational axis AX1. Each of the fins 172 extends from the cylindrical part 171b to a radially outer edge of the tapered cylindrical part 171a.

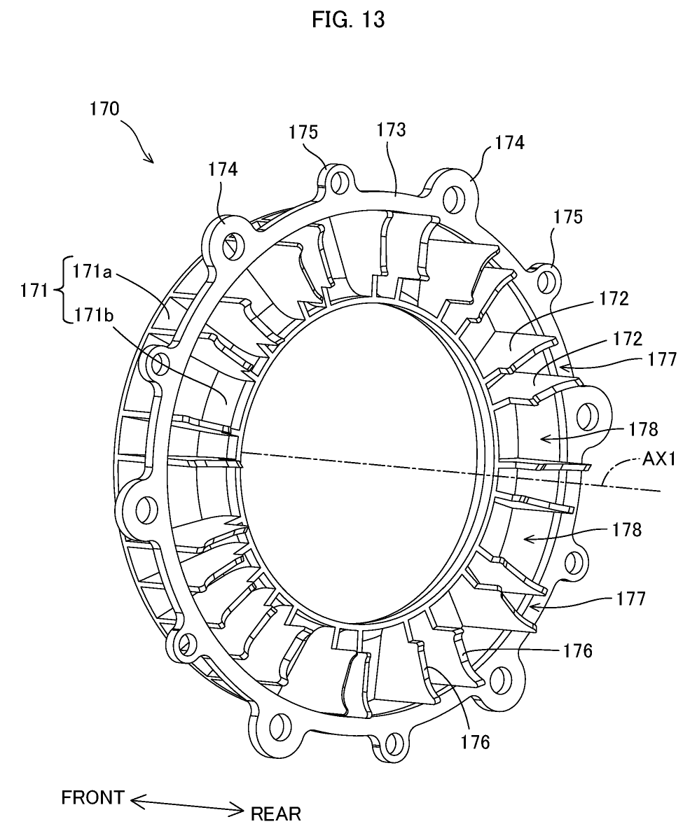

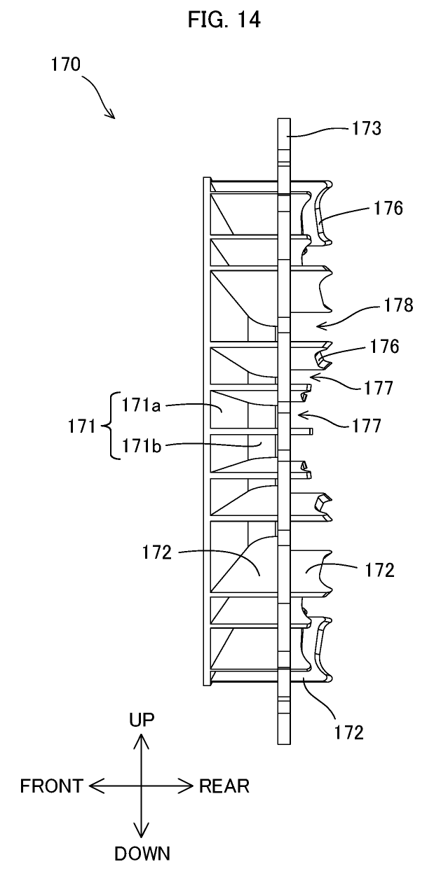

As shown in FIG. 13, the fins 172 are not equidistantly arranged apart from each other in the circumferential direction. Thus, the spaces between the fins 172 (the spaces partitioned by the fins 172 in the circumferential direction) include first spaces 177 where the distance between the two adjacent fins 172 is smaller and second spaces 178 where the distance between the two adjacent fins 172 is larger. As shown in FIG. 14, each of the fins 172 has a height (width in the front-rear direction) different from the others.

As shown in FIGS. 13 and 14, the mounting ring 173 has an annular shape, and is connected to radially outer side surfaces of the fins 172. The mounting ring 173 is integrally formed with the fins 172, for example, by welding. As shown in FIG. 14, the mounting ring 173 is connected to the fins 172 in the vicinity of a tip 176 of the fin 172 having the smallest height among the fins 172. As shown in FIG. 13, the mounting ring 173 includes first mounting parts 174 and second mounting parts 175. Each of the first and second mounting parts 174, 175 protrudes radially outward and has a through hole extending in the front-rear direction. The first and second mounting parts 174, 175 are equidistantly arranged in the circumferential direction.

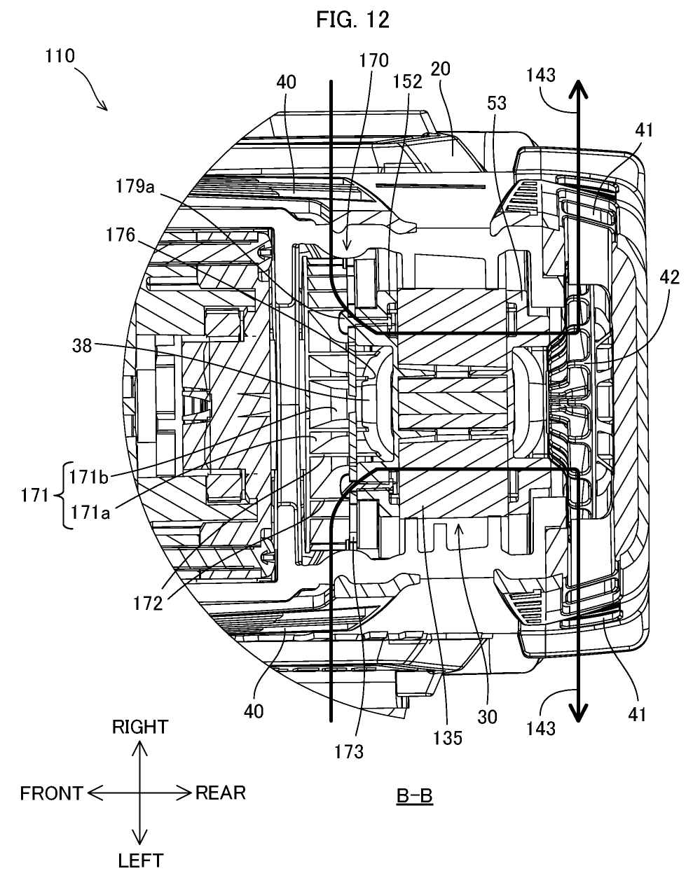

The heat sink 170 is mounted to the front insulator 152 by a simple structure utilizing the mounting ring 173. Specifically, as shown in FIGS. 9, 10 and 12, the heat sink 170 is mounted to the front insulator 152 by screws 179a being inserted into the first mounting parts 174 of the mounting ring 173 and screw bosses 152a of the front insulator 152 and tightened. At this time, the screw bosses 137c of the stator 135 are fitted in the positioning parts 152b of the front insulator 152. Each of the positioning parts 152b is in the form of a through hole or a notch that has a shape conforming to the screw bosses 137c. The heat sink 170 is also fixed to the stator 135 by screws 179b being inserted into the second mounting parts 175 of the mounting ring 173 and the screw bosses 137c of the stator 135 and tightened. With this structure, the heat sink 170 is positioned relative to the stator 135. Particularly, the relative rotation angle position of the heat sink 170 relative to the stator 135 is positioned. As shown in FIG. 12, the fins 172 are held in contact with the coils 38 wound around the teeth 137 of the stator 135 when the heat sink 170 is mounted.

As shown in FIG. 12, the heat sink 170 is arranged in a flow passage 143 of the motor cooling air that is led into the main housing 20 from the inlets 40 and discharged from the outlets 41. The motor cooling air flowing into the main housing 20 from the inlets 40 is led radially inward through the spaces between the fins 172, or the first and second spaces 177, 178, then changed in the flow direction to the axial direction by the cylindrical part 171b, and passes through the motor 30 rearward from the front. The motor cooling air is then changed in the flow direction to the radially outward direction by the motor cooling fan 42, and discharged from the outlets 41.

The heat sink 170 is arranged in contact with the coils 38, so that heat exchange is efficiently performed between the heat sink 170 and the motor cooling air, and the motor 30 is efficiently cooled. Particularly, since the motor 30 generates heat mainly at the coils 38, the cooling efficiency is further improved by provision of the heat sink 170 arranged in contact with the coils 38. Furthermore, by provision of the heat sink 170 including the fins 172, the cooling efficiency is further improved.

Further, according to the heat sink 170, the spaces between the fins 172, or the first and second spaces 177, 178 serve as part of the flow passage 143. Thus, the motor cooling air is efficiently led in a desired direction. Therefore, compared with a structure in which the heat sink 170 is arranged so as to obstruct the flow of the motor cooling air, the pressure loss of the flow passage 143 is reduced, and the motor 30 is efficiently cooled. Further, the first and second spaces 177, 178 lead the motor cooling air in the radial direction, so that the motor cooling air is led in the radial direction through an efficient flow path by the fins 172, while obtaining the effect of improving the cooling efficiency by the fins 172.

Further, the heat sink 170 is arranged at a position corresponding to the inlets 40 in the front-rear direction. Thus, the motor cooling air of a relatively low temperature before passing through the motor 30 comes into contact with the heat sink 170. Therefore, the cooling efficiency by the heat sink 170 is improved. Further, as shown in FIG. 12, the first and second spaces 177, 178 that serve as the flow passages are arranged at a position corresponding to the inlets 40 in the front-rear direction. Thus, the inlets 40 are in communication with the first and second spaces 177, 178 via the shortest flow path in the front-rear direction, so that the flow path of the motor cooling air from the inlets 40 to the motor 30 is further improved in efficiency in the front-rear direction, and the motor 30 is more efficiently cooled.

Further, according to the heat sink 170, as shown in FIGS. 12-14, the tips 176 of the fins 172 have a shape conforming to the coils 38. More specifically, each of the tips 176 includes a central part recessed and both ends in the radial direction protruding from the central part so as to conform to the curved shape of the wound coils 38. With this structure, the area of contact between the fins 172 and the coils 38 is increased, so that the motor 30 is more efficiently cooled by the fins 172. Further, as described above, the fins 172 have different heights from one another so as to conform to the curved shape of the wound coils 38. Therefore, as shown in FIG. 12, all of the fins 172 are reliably held in contact with the coils 38. Also with this structure, the area of contact between the fins 172 and the coils 38 is increased, and the cooling efficiency is improved. Furthermore, the driver drill 10 has a structure for positioning the relative rotation angle position of the heat sink 170 relative to the stator 135, so that the tips 176 are more reliably conformed to the coils 38.

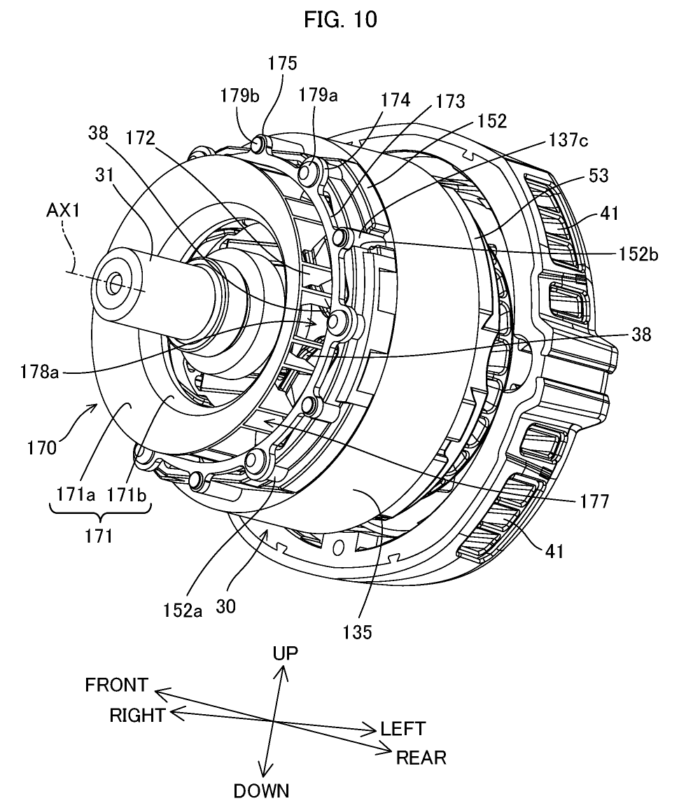

Further, according to the heat sink 170, as shown in FIG. 10, the second space 178 that is larger than the first space 177 (in other words, the second space 178 through which the motor cooling air most easily passes) is located at least at a position corresponding to a clearance between the teeth 137 around which the coils 38 are wound (that is, a clearance between the two adjacent coils 38 of different phases in the slot 39), in the circumferential direction. In FIG. 10, such second space 178 is shown as a second space 178a. With this structure, a larger amount of the motor cooling air comes into contact with the coils 38 that are heat generating parts, so that the cooling efficiency for the motor 30 is further improved.

Further, according to the driver drill 110, a sensorless brushless motor is used as the motor 30, so that an installation space for a sensor substrate is not needed. Thus, by arranging the heat sink 170 in the installation space for a sensor substrate, the cooling efficiency for the motor 30 is improved by the heat sink 170 without increasing the tool size in the front-rear direction, compared with a driver drill including a sensor substrate.

Having described several embodiments, the above-described embodiments are intended to only facilitate the understanding of the present teachings, and are not intended to limit the present invention thereto. The present invention can be modified or improved without departing from the spirit thereof, and the present invention includes equivalents thereof. Further, each of the forms/elements described in the claims and the specification can be combined in any manner or omitted in any manner within a range that allows it to remain capable of achieving at least a part of the above-described objects or bringing about at least a part of the above-described advantageous effects.

The positional relationship between the inlets 40 and the outlets 41 may be opposite to that of the above-described embodiment. Specifically, the inlets 40 may be arranged behind the motor 30, while the outlets 41 and the motor cooling fan 42 may be arranged in front of the motor 30.

The heat sink 170 may be arranged between the stator 135 and the motor cooling fan 42 in the front-rear direction instead of or in addition to the above-described position. When the heat sink 170 is arranged between the stator 135 and the motor cooling fan 42 behind the stator 135, the first and second spaces 177, 178 serve as the flow passages to lead the motor cooling air from the motor 30 to the outlets 41.

The fins 172 of the heat sink 170 may be arranged in contact with any part of the motor 30 (such as the stator 135) in addition to or in place of the coils 38. Further, for example, the heat sink 170 may be changed into any shape and layout in so far as the heat sink 170 is arranged in the flow passage of the motor cooling air so as to be held in contact with the motor 30.

The first and second embodiments may be combined with each other. Specifically, the driver drill may include the bracket 60 having the flow passage grooves 65, and the heat sink 170. In this case, the heat sink 170 may be arranged between the bracket 60 and the motor 30 in the front-rear direction, and changed into any shape that does not obstruct the flow of the motor cooling air. Alternatively, in the driver drill 10 of the first embodiment, the heat sink 170 may be arranged between the motor 30 and the motor cooling fan 42.

The above-described embodiments can be applied not only to the oscillating impact driver (vibration drill), but also to various kinds of fastening tools such as an impact driver that does not have an oscillating function. Further, the above-described embodiments can be applied not only to fastening tools, but also to various kinds of power tools including a brushless electric motor and a motor cooling structure.

The above-described motor cooling structure including the bracket 60 or the heat sink 170 may be applied in a power tool that is provided with a motor including a sensor substrate for detecting the rotation angle position of the rotor.

### DESCRIPTION OF THE REFERENCE NUMERALS

10: driver drill, 20: main housing, 21: handle housing, 22: battery holding part, 22a: battery mounting part, 23: chuck, 23a: claw part, 24: speed reducing mechanism, 25: vibration mechanism, 26: spindle, 27: trigger, 28: battery, 29: controller, 30: motor, 31: motor shaft, 32: rotor, 33: rotor core, 34: magnet, 35: stator, 36: yolk, 37: teeth, 38: coil, 39: slot, 40: inlet, 41: outlet, 42: motor cooling fan, 43: flow passage, 50: first bearing, 51: second bearing, 52: front insulator, 53: rear insulator, 60: bracket, 61: conical cylinder part, 62: gear holding part, 63: bearing support part, 64: screw boss, 65: flow passage groove, 66, 67: side wall, 110: driver drill, 135: stator, 136: yolk, 137: teeth, 137a: through hole, 137b: positioning member, 137c: screw boss, 143: flow passage, 152: front insulator, 152a: screw boss, 152b: positioning part, 160: bracket, 170: heat sink, 171: base, 171a: tapered cylindrical part, 171b: cylindrical part, 172: fin, 173: mounting ring, 174: first mounting part, 175: second mounting part, 176: tip, 177: first space, 178, 178a: second space, 179a, 179b: screw, AX1: rotational axis

1. A power tool comprising:
a brushless electric motor including a rotor, a stator, and a motor shaft;
a first bearing that is arranged on a first side relative to the rotor and the stator in an axial direction in which the motor shaft extends, and rotatably supports the motor shaft;
a second bearing that is arranged on a second side opposite to the first side in the axial direction, and rotatably supports the motor shaft;
a housing that includes at least one inlet on the first side and at least one outlet on the second side, and houses the brushless electric motor therein; and
a bracket supporting the first bearing;
wherein the bracket includes at least one flow passage groove configured to direct motor cooling air flowing into the housing from the at least one inlet, toward the brushless electric motor.

2. The power tool as defined in claim 1, wherein the at least one flow passage groove is located at a position corresponding to the at least one inlet in the axial direction.

3. The power tool as defined in claim 1, wherein the at least one flow passage groove is located at a position corresponding to the at least one inlet in a circumferential direction relative to the motor shaft.

4. The power tool as defined in claim 1, wherein the at least one inlet includes a plurality of inlets, and
the at least one flow passage groove includes a plurality of flow passage grooves that are respectively located at a plurality of positions corresponding to the plurality of inlets.

5. The power tool as defined in claim 1, wherein the stator includes a plurality of teeth around which coils are wound, and
the at least one flow passage groove is configured to direct the motor cooling air to flow through a clearance between the plurality of teeth around which the coils are wound.

6. The power tool as defined in claim 5, wherein the at least one flow passage groove has a passage width that decreases from an upstream side toward a downstream side of the motor cooling air.

7. The power tool as defined in claim 1, wherein the stator includes a plurality of teeth around which coils are wound, and
the power tool further includes a heat sink that is arranged in contact with the coils wound around the plurality of teeth, in a flow passage of the motor cooling air.

8. A power tool comprising:
a brushless electric motor including a rotor, a stator including a plurality of teeth around which coils are wound, and a motor shaft having a rotational axis;
a first bearing that is arranged on a first side relative to the rotor and the stator in an axial direction in which the rotational axis extends, and rotatably supports the motor shaft;
a second bearing that is arranged on a second side opposite to the first side in the axial direction, and rotatably supports the motor shaft;
a housing that includes at least one inlet on the first side and at least one outlet on the second side, and houses the brushless electric motor therein; and
a heat sink that is arranged in contact with the coils wound around the plurality of teeth, in a flow passage of motor cooling air that flows into the housing from the at least one inlet and is discharged from the at least one outlet.

9. A power tool comprising:
a brushless electric motor including a rotor, a stator including a plurality of teeth around which coils are wound, and a motor shaft having a rotational axis;
a first bearing that is arranged on a first side relative to the rotor and the stator in an axial direction in which the rotational axis extends, and rotatably supports the motor shaft;
a second bearing that is arranged on a second side opposite to the first side in the axial direction, and rotatably supports the motor shaft;
a housing including at least one inlet on the first side and at least one outlet on the second side, and housing the brushless electric motor therein; and
a heat sink that is arranged in contact with the brushless electric motor, in a flow passage of motor cooling air that flows into the housing from the at least one inlet and is discharged from the at least one outlet;
wherein the heat sink includes a plurality of fins, and
a plurality of spaces between the plurality of fins function as flow passages that lead the motor cooling air from the at least one inlet to the brushless electric motor, or flow passages that lead the motor cooling air from the brushless electric motor to the at least one outlet.

10. The power tool as defined in claim 8, wherein the heat sink includes a plurality of fins that are arranged in contact with the coils wound around the plurality of teeth.

11. The power tool as defined in claim 9, wherein:
the plurality of fins are arranged to extend radially relative to the rotational axis; and
a plurality of spaces between the plurality of fins function as flow passages that lead the motor cooling air in a radial direction relative to the rotational axis.

12. The power tool as defined in claim 11, wherein the plurality of spaces include a first space in which a distance in a circumferential direction relative to the rotational axis between two fins adjacent in the circumferential direction is a first distance, and a second space in which a distance between the two fins adjacent in the circumferential direction is a second distance larger than the first distance, and
the second space is located at least at a position corresponding to a clearance between the plurality of teeth around which the coils are wound.

13. The power tool as defined in claim 10, wherein each of the plurality of fins includes a tip that has a shape conforming to the coils wound around the teeth.

14. The power tool as defined in claim 8, wherein the heat sink is located at a position corresponding to the at least one inlet in the axial direction.

15. The power tool as defined in claim 8, further comprising an insulator that surrounds the coils wound around the plurality of teeth, along a circumferential direction on an outer side of the coils in a radial direction,
wherein the heat sink is screwed to the insulator.
